(19) United States
(12) Patent Application Publication
(10) Pub. No.: US 2026/0232003 A1
(43) Pub. Date: Aug. 13, 2026

(54) FOOD ITEM FABRICATION SYSTEM AND METHOD FOR FABRICATING FOOD ITEM

(71) Applicant: MIMAKI ENGINEERING CO., LTD., Nagano (JP)

(72) Inventors: Akira Ikeda, Nagano (JP); Kazutomo Seki, Nagano (JP)

(73) Assignee: MIMAKI ENGINEERING CO., LTD., Nagano (JP)

(21) Appl. No.: 19/102,843

(22) PCT Filed: Aug. 31, 2023
(86) PCT No.: PCT/JP2023/031685

§ 371 Date: Feb. 10, 2025

(30) Foreign Application Priority Data
Sep. 6, 2022 (JP) 2022-141768

(51) Int. Cl. A23P 20/15; A23P 20/25; B33Y 30/00; B33Y 40/00

(52) U.S. Cl. CPC A23P 20/15; B33Y 30/00; B33Y 40/00; A23P 2020/253

(57) ABSTRACT

A food item fabrication system and a method for fabricating a food item are provided to accurately fabricate a fabricated food item. The food item fabrication system includes a discharge head, a data generation unit and a discharge control unit. The discharge head intermittently discharges a fabrication material for fabricating a fabricated food item, the fabrication material having a fluidity at a time of discharge. The data generation unit generates a slice data for fabricating the fabricated food item. The discharge control unit controls a discharge of the fabrication material by the discharge head based on the slice data generated by the data generation unit.

### TECHNICAL FIELD

The present disclosure relates to a food item fabrication system and a method for fabricating a food item.

### BACKGROUND ART

Currently, a 3D food printer that fabricates a fabricated food item, which is an edible fabricated object, by applying a technique of a three-dimensional (3D) printer is known. The 3D food printer, for example, fabricates a fabricated food item by layering edible fabrication materials.

For example, Patent Literature 1 describes a technique of fabricating a fabricated food item using an extrusion method to which fused deposition modeling (FDM) is applied. In the technique described in Patent Literature 1, when forming each layer constituting the fabricated food item, a food composition having an adjusted viscosity is extruded from a nozzle and deposited on a lower layer.

### CITATION LIST

### Patent Literature

Patent Literature 1: U.S. Pat. No. 6,280,785

### SUMMARY OF INVENTION

### Technical Problems

However, in the extrusion method described in Patent Literature 1, the food item composition is basically continuously discharged from the nozzle like a single stroke. Therefore, when the fabrication material is layered using the extrusion method described in Patent Literature 1, it is difficult to accurately fabricate the fabricated food item. Therefore, a technique for accurately fabricating a fabricated food item is desired.

The present disclosure has been made in view of the above problems, and an object thereof is to provide a food item fabrication system and a method for fabricating a food item for accurately fabricating a fabricated food item.

### Solutions to Problems

In order to achieve the above object, a food item fabrication system according to a first aspect of the present disclosure includes:
a food item fabrication system for fabricating a fabricated food item by layering a fabrication material, the food item fabrication system including:
a discharge head, configured to intermittently discharge a fabrication material for fabricating the fabricated food item, the fabrication material having a fluidity at a time of discharge,
a data generation unit, configured to generate a slice data for fabricating the fabricated food item, and
a discharge control unit, configured to control a discharge of the fabrication material by the discharge head based on the slice data generated by the data generation unit.

A plurality of discharge heads that discharge a plurality of fabrication materials, respectively, may be further provided, wherein
the data generation unit may be configured to generate the slice data including at least one of a data which has a raster data and a vector data for each of the plurality of fabrication materials, and
the discharge control unit may be configured to control the discharge of each of the plurality of fabrication materials by the plurality of discharge heads based on the corresponding at least one of the data.

The plurality of discharge heads may include: a first discharge head, configured to discharge a first fabrication material; and a second discharge head, configured to discharge a second fabrication material,
the data generation unit may be configured to generate the slice data including a first vector data that is a vector data for the first fabrication material and a first raster data that is a raster data for the second fabrication material, and
the discharge control unit may be configured to control a discharge of the first fabrication material by the first discharge head based on the first vector data, and control a discharge of the second fabrication material by the second discharge head based on the first raster data.

The discharge control unit may be configured to control the first discharge head to discharge the first fabrication material to a first region that is a region corresponding to an outer edge of the fabricated food item based on the first vector data, and control the second discharge head to discharge the second fabrication material to a second region that is a region surrounded by the first region based on the first raster data.

A viscosity of the first fabrication material may be higher than a viscosity of the second fabrication material, and
the discharge control unit may be configured to control the first discharge head to discharge the first fabrication material to the first region based on the first vector data, and then control the second discharge head to discharge the second fabrication material to the second region based on the first raster data.

The data generation unit may be configured to generate the slice data including the first vector data, the first raster data, and a second raster data that is a raster data for the first fabrication material, and
the discharge control unit may be configured to execute a process of controlling the first discharge head to discharge the first fabrication material to the first region based on the first vector data, and then control the second discharge head to discharge the second fabrication material to the second region based on the first raster data, and execute a process of controlling the first discharge head to discharge the first fabrication material to a third region that is a region surrounded by the first region and different from the second region based on the second raster data.

The plurality of discharge heads may include: a first discharge head, configured to discharge a first fabrication material having a first viscosity; and a second discharge head, configured to discharge a second fabrication material having a second viscosity lower than the first viscosity,
the discharge control unit may be configured to: control the first discharge head to discharge the first fabrication material, and then control the second discharge head to discharge the second fabrication material.

The data generation unit may be configured to generate the slice data including a raster data for each of the plurality of fabrication materials, and
the discharge control unit may be configured to control a discharge of each of the plurality of fabrication materials by the plurality of discharge heads based on the corresponding raster data.

The plurality of discharge heads may be arranged side by side in a main scanning direction.

In order to achieve the above object, a method for fabricating a food item according to a second aspect of the present disclosure includes:
a method for fabricating a food item for fabricating a fabricated food item by layering fabrication materials, the method including:
intermittently discharging the fabrication material for fabricating the fabricated food item, the fabrication material having a fluidity at a time of discharge,
generating a slice data for fabricating the fabricated food item, and
controlling a discharge of the fabrication material based on the slice data.

### Effect of the Invention

According to the present disclosure, a fabricated food item can be accurately fabricated.

### BRIEF DESCRIPTION OF THE DRAWINGS

FIG. 1 is a configuration diagram of a food item fabrication system according to an embodiment of the present disclosure.

FIG. 2 is a perspective view of a moving mechanism included in the food item fabrication system according to the embodiment of the present disclosure.

FIG. 3 is an explanatory view of a method of discharging a fabrication material.

FIG. 4 is an explanatory view of a discharge region of a fabrication material.

FIG. 5 is an explanatory diagram of a discharge control based on vector data for a soybean paste.

FIG. 6 is an explanatory diagram of a discharge control based on raster data for a soybean paste.

FIG. 7 is an explanatory diagram of a discharge control based on raster data for an oil/fat paste.

FIG. 8 is a flowchart illustrating a food item fabricating process executed by the food item fabrication system according to the embodiment of the present disclosure.

### DESCRIPTION OF EMBODIMENTS

### Embodiment

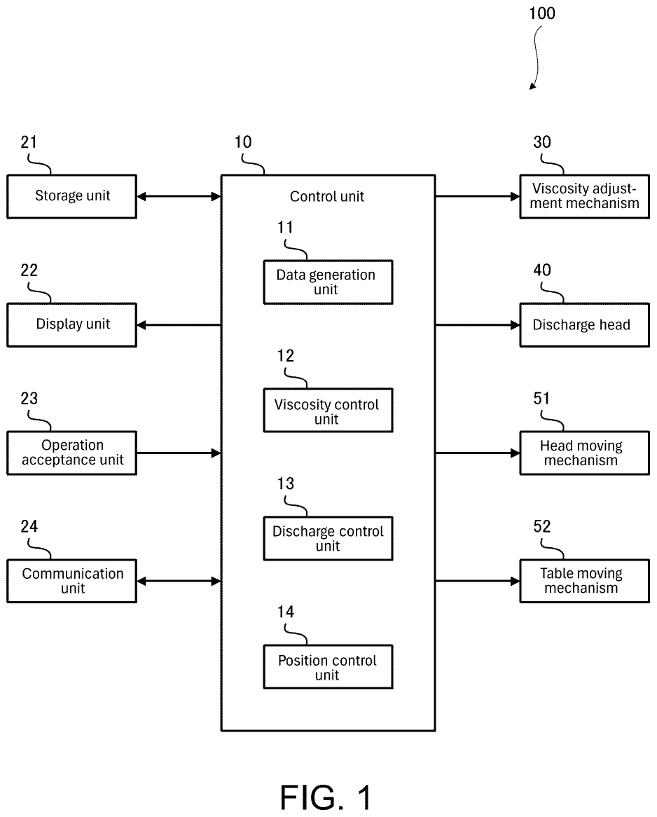

First, a configuration of a food item fabrication system 100 according to an embodiment of the present disclosure will be described with reference to FIG. 1. The food item fabrication system 100 is a system that fabricates a fabricated food item, which is an edible fabricated object, by applying a technology of a three-dimensional (3D) printer. The food item fabrication system 100 fabricates a fabricated food item by layering edible fabrication materials. As illustrated in FIG. 1, the food item fabrication system 100 includes a control unit 10, a storage unit 21, a display unit 22, an operation acceptance unit 23, a communication unit 24, a viscosity adjustment mechanism 30, a discharge head 40, a head moving mechanism 51, and a table moving mechanism 52. The food item fabrication system 100 may be implemented by one device or may be implemented by cooperation of a plurality of devices.

The control unit 10 controls the operation of the entire food item fabrication system 100. The control unit 10 includes a central processing unit (CPU), a read only memory (ROM), a random access memory (RAM), a real time clock (RTC), and the like. The CPU is also referred to as a central processing unit, a central arithmetic unit, a processor, a microprocessor, a microcomputer, a digital signal processor (DSP), or the like, and functions as a central processing unit that executes process and calculation related to control of the food item fabrication system 100. In the control unit 10, the CPU reads programs and data stored in the ROM, and integrally controls the food item fabrication system 100 using the RAM as a work area. The RTC is, for example, an integrated circuit having a timing function. Note that the CPU can specify the current date and time from the time information read from the RTC.

The storage unit 21 includes a nonvolatile semiconductor memory such as a flash memory, an erasable programmable ROM (EPROM), or an electrically erasable programmable ROM (EEPROM), and serves as a so-called secondary storage device or an auxiliary storage device. The storage unit 21 stores programs and data used by the control unit 10 to execute various processes. In addition, the storage unit 21 stores data generated or acquired by the control unit 10 executing various processes.

The display unit 22 displays various images according to the control of the control unit 10. The display unit 22 includes a touch screen, a liquid crystal display, and the like. The operation acceptance unit 23 accepts various operations from a user and supplies information indicating contents of the accepted operation to the control unit 10. The operation acceptance unit 23 includes a touch screen, a button, a lever, and the like.

The communication unit 24 communicates with various devices according to the control of the control unit 10. The communication unit 24 communicates with various devices in accordance with various wireless communication standards or various wired communication standards. Various wireless communication standards include Wi-Fi (registered trademark), long term evolution (LTE), 4G (4th Generation), 5G (5th Generation), Bluetooth (registered trademark), and Zigbee (registered trademark). Various wired communication standards include universal serial bus (USB, registered trademark), Thunderbolt (registered trademark), and the like. The communication unit 24 includes a communication interface conforming to various communication standards.

The viscosity adjustment mechanism 30 is a mechanism for adjusting the viscosity of the fabrication material to be discharged according to the control of the control unit 10. The fabrication material is a fabrication material for fabricating a fabricated food item, and is a fabrication material having fluidity at the time of discharge. Having fluidity means flowing without being fixed. The fabrication material is suitably in a gel form or a paste form and has a high viscosity at the time of discharge.

The fabrication material may be any material as long as the material can fabricate the fabricated food item. For example, a soybean paste, an oil/fat paste, a rice jelly, and a soybean curd paste are conceivable as the fabrication material. In the present embodiment, the fabricated food item is an artificial meat 200, and the fabrication material is two types, the soybean paste for forming the lean portion and the oil/fat paste for forming the fat portion.

The viscosity of the fabrication material varies according to the temperature of the fabrication material. Therefore, the viscosity adjustment mechanism 30 adjusts the viscosity of the fabrication material to be discharged by adjusting the temperature of the fabrication material to be discharged. The viscosity adjustment mechanism 30 includes a material flow path (not illustrated) through which the fabrication material flows, a heater (not illustrated) that heats the material flow path according to the control of the control unit 10, a cooler (not illustrated) that cools the material flow path according to the control of the control unit 10, and a temperature sensor (not illustrated) that measures the temperature of the fabrication material or the material flow path.

The viscosity adjustment mechanism 30 heats the fabrication material to be supplied to the discharge head 40 to reduce the viscosity of the fabrication material. Alternatively, the viscosity adjustment mechanism 30 cools the fabrication material to be supplied to the discharge head 40 to increase the viscosity of the fabrication material. The viscosity adjustment mechanism 30 sets the temperature of the fabrication material to a predetermined temperature so that the viscosity of the fabrication material becomes a predetermined viscosity. Note that the control unit 10 can specify the predetermined viscosity and the predetermined temperature of the fabrication material with reference to, for example, the material information stored in the storage unit 21. The material information is, for example, information indicating a predetermined viscosity and a predetermined temperature for each fabrication material.

In the present embodiment, the viscosity at the time of discharging the fabrication material is high, and the fabrication material is quickly dried and cured after being discharged. Therefore, in the present embodiment, a heater for drying the discharged fabrication material is not provided. Note that the viscosity of the soybean paste is preferably about 700,000 cps, and the viscosity of the oil/fat paste is preferably about 70,000 to 100,000 cps. Furthermore, in the present embodiment, the viscosity at the time of discharging the fabrication material is appropriately simply referred to as the viscosity of the fabrication material.

The discharge head 40 intermittently discharges the fabrication material according to the control of the control unit 10. Intermittent discharge means repeating discharge intermittently. That is, the discharge head 40 continuously discharges the particulate fabrication material. The discharge head 40 discharges the fabrication material by, for example, a micro dispenser method of outputting the fabrication material every time the screw makes one rotation, or an inkjet method such as a piezo method or a thermal head method. Note that the fabrication material flows along a route of a material tank (not illustrated), the viscosity adjustment mechanism 30, and the discharge head 40.

The number of discharge heads 40 is suitably adjusted according to the number of types of fabrication materials, the ratio of each fabrication material in the fabricated food item, and the like. In the present embodiment, the food item fabrication system 100 includes two discharge heads 40, a discharge head 40 that discharges a soybean paste and a discharge head 40 that discharges an oil/fat paste. What to adopt for the discharge head 40 can be appropriately adjusted. For example, VTK-VS-BA-048e manufactured by VERMES Microdispensing GmbH Co. can be adopted as the discharge head 40.

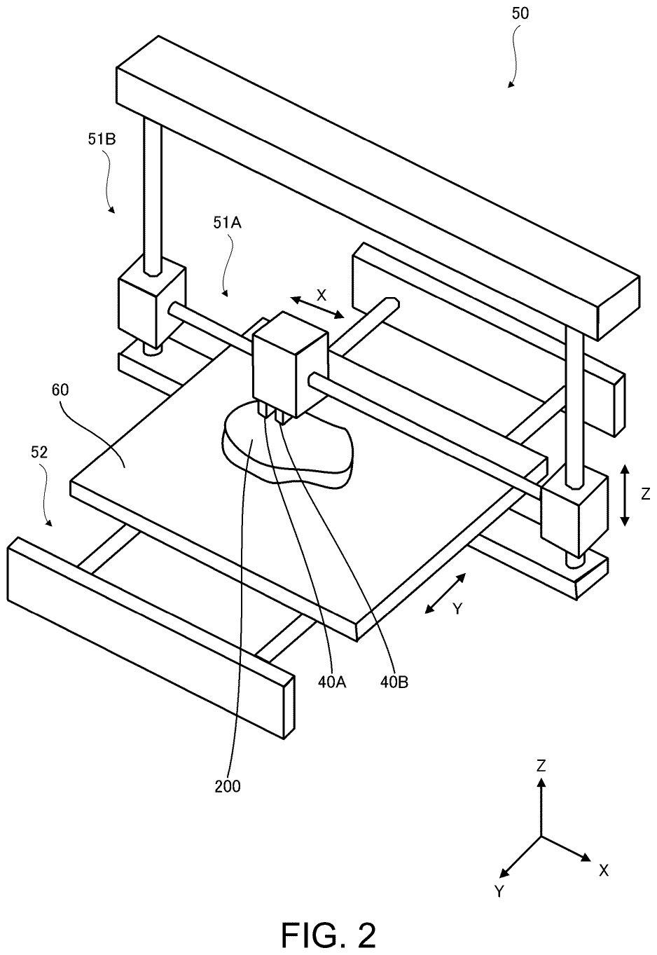

The head moving mechanism 51 is a mechanism that moves the discharge head 40 according to the control of the control unit 10. The table moving mechanism 52 is a mechanism that moves a table 60 illustrated in FIG. 2 according to the control of the control unit 10. The table 60 is a table onto which the fabrication material is discharged, and is a table on which the fabricated food item is placed. Hereinafter, the moving mechanism 50 included in the food item fabrication system 100 will be described with reference to FIG. 2. The moving mechanism 50 is a mechanism that changes a relative positional relationship between the discharge head 40 and the table 60.

In FIG. 2, the Z axis is an axis extending in the vertical direction, the X-axis is an axis orthogonal to the Z-axis, and the Y-axis is an axis orthogonal to the X-axis and the Z-axis. In the present embodiment, the X-axis direction is the main scanning direction, and the Y-axis direction is the sub scanning direction. The main scanning direction is a direction in which the discharge head 40 moves along one line when the fabrication material is discharged for each line in the raster control. The sub scanning direction is a direction in which the discharge head 40 moves when the line is switched in the raster control. A direction in which the arrow of the X-axis extends is a positive direction of the X-axis, and a direction opposite to the direction in which the arrow of the X-axis extends is a negative direction of the X-axis. A direction in which the arrow of the Y-axis extends is a positive direction of the Y-axis, and a direction opposite to the direction in which the arrow of the Y-axis extends is a negative direction of the Y-axis. A direction in which the arrow of the Z-axis extends is a positive direction of the Z-axis, and a direction opposite to the direction in which the arrow of the Z-axis extends is a negative direction of the Z-axis.

The moving mechanism 50 includes a head moving mechanism 51A, a head moving mechanism 51B, and a table moving mechanism 52. The head moving mechanism 51A is a mechanism that moves the discharge head 40 along the X-axis direction according to the control of the control unit 10. The head moving mechanism 51B is a mechanism that moves the discharge head 40 along the Z-axis direction according to the control of the control unit 10. The table moving mechanism 52 is a mechanism that moves the table 60 along the Y-axis direction according to the control of the control unit 10.

Note that the head moving mechanism 51 described above includes the head moving mechanism 51A and the head moving mechanism 51B. Furthermore, the discharge head 40 is a general term for the discharge head 40A and the discharge head 40B. The discharge head 40A discharges the soybean paste. The discharge head 40B discharges the oil/fat paste. The discharge head 40A and the discharge head 40B are disposed along the main scanning direction.

The control unit 10 controls the head moving mechanism 51A to adjust the relative positions of the discharge head 40 and the table 60 in the X-axis direction. The control unit 10 controls the table moving mechanism 52 to adjust the relative positions of the discharge head 40 and the table 60 in the Y-axis direction. The control unit 10 controls the head moving mechanism 51B to adjust the relative positions of the discharge head 40 and the table 60 in the Z-axis direction.

Each of the head moving mechanism 51A, the head moving mechanism 51B, and the table moving mechanism 52 includes, for example, a carriage (not illustrated), a guide rail (not illustrated), a drive belt (not illustrated), a drive pulley (not illustrated), a driven pulley (not illustrated), and a drive motor (not illustrated). A moving object such as the discharge head 40 and the table 60 is mounted on the carriage. The guide rail guides movement of the carriage in a predetermined direction. The drive belt is fixed to the carriage. The drive belt is wound around the drive pulley and the driven pulley. The drive motor rotates the drive belt by way of the drive pulley to move the carriage in the predetermined direction. Note that the predetermined direction in the head moving mechanism 51A is the X-axis direction, the predetermined direction in the table moving mechanism 52 is the Y-axis direction, and the predetermined direction in the head moving mechanism 51B is the Z-axis direction.

Next, main functions of the control unit 10 will be described in detail. The control unit 10 functionally includes a data generation unit 11, a discharge control unit 13, a viscosity control unit 12, and a position control unit 14. Each of these functions is implemented by software, firmware, or a combination of software and firmware. The software and the firmware are described as programs and stored in the ROM or the storage unit 21. Then, the CPU executes the program stored in the ROM or the storage unit 21 to implement each of these functions.

The data generation unit 11 generates slice data for fabricating a fabricated food item. The slice data is data obtained by dividing a 3D model of the fabricated food item, which is a finished product, for each layer. For example, the data generation unit 11 slices the 3D model of the fabricated food item stored in the storage unit 21, and generates slice data defining a place where the fabrication material is to be discharged in each layer. What kind of data to have the slice data can be appropriately adjusted. For example, the slice data may include at least one of raster data and vector data for each of the plurality of fabrication materials. That is, the slice data may include only raster data, only vector data, or raster data and vector data for each of the plurality of fabrication materials.

The raster data is data configured by cells arranged in a grid of rows and columns. That is, the raster data is data in which a value is assigned to each cell like bitmap data. In the raster control, which is discharge control using raster data, the fabrication material can be discharged for each cell. Therefore, according to the raster control, highly accurate discharge can be performed. The raster control is control of an image in which a point is drawn in units of dots using coordinates, and is control suitable for finely forming the inner portion of the fabricated food item. The raster data is prepared for each layer and each fabrication material.

The vector data is data in which coordinates of points or a line connecting points are expressed by numerical data. The vector data is, for example, data representing a trajectory on which the fabrication material is discharged by the discharge head 40. In the vector control, which is discharge control using vector data, the fabrication material can be continuously discharged. Therefore, according to the vector control, an increase in fabricating speed can be expected. The vector control is control of an image of drawing a line, and is control suitable for quickly forming a wall of an outer peripheral portion of the fabricated food item. The vector data is prepared for each layer and each fabrication material.

The viscosity control unit 12 executes adjustment of the viscosity of the fabrication material by the viscosity adjustment mechanism 30. Specifically, the viscosity control unit 12 heats or cools the material flow path included in the viscosity adjustment mechanism 30 using a heater or a cooler included in the viscosity adjustment mechanism 30 so that the viscosity of the fabrication material supplied from the viscosity adjustment mechanism 30 to the discharge head 40 becomes a predetermined viscosity.

The discharge control unit 13 controls the discharge of the fabrication material by the discharge head 40 based on the slice data generated by the data generation unit 11. The discharge control unit 13 causes the discharge head 40 to discharge the fabrication material when the discharge head 40 is disposed above the region where the fabrication material is to be discharged designated by the slice data. For example, in a case where the slice data includes raster data, the discharge control unit 13 causes the discharge head 40 to discharge the fabrication material when the discharge head 40 is disposed above the cell where the fabrication material is to be discharged designated by the raster data. Furthermore, for example, in a case where the slice data includes vector data, the discharge control unit 13 causes the discharge head 40 to discharge the fabrication material when the discharge head 40 moves along the trajectory on which the fabrication material is to be discharged designated by the vector data.

The discharge control unit 13 controls the discharge of each of the plurality of fabrication materials by the plurality of discharge heads 40 based on the corresponding raster data or vector data. For example, the discharge control unit 13 controls the discharge of the soybean paste by the discharge head 40A based on the raster data or vector data corresponding to the soybean paste. The discharge control unit 13 controls the discharge of the oil/fat paste by the discharge head 40B based on the raster data or vector data corresponding to the oil/fat paste.

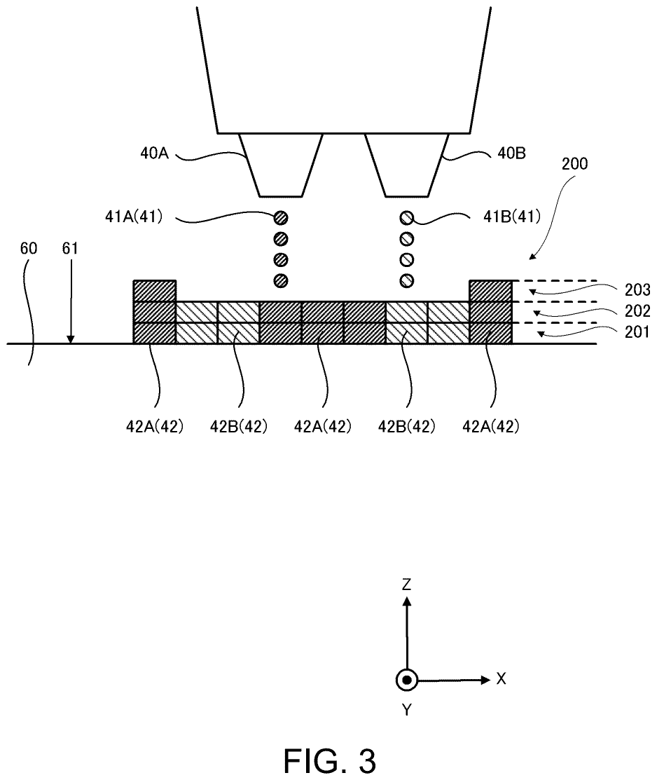

Here, a method of discharging the fabrication material will be described with reference to FIG. 3. The discharge head 40 intermittently discharges the fabrication material. That is, the discharge head 40 continuously discharges the particle 41 which is a particulate fabrication material. The discharged particle 41 is deposited on the table 60 or the lower layer as a deposit 42. For example, the discharge head 40A continuously discharges soybean particle 41A which is a particulate soybean paste. The discharged soybean particle 41A is deposited on the table 60 or the lower layer as a deposit 42A. Furthermore, the discharge head 40B continuously discharges the oil/fat particle 41B which is a particulate oil/fat paste. The discharged oil/fat particle 41B is deposited on the table 60 or the lower layer as a deposit 42B. The size of the particle 41 is appropriately adjusted, for example, according to the viscosity. For example, the diameter of the particle 41 is suitably about 30 micrometers.

Furthermore, the food item fabrication system 100 controls the discharge of the fabrication material for each layer to generate the fabricated food item for each layer. FIG. 3 illustrates a state in which a deposited layer 203 is being formed on a deposited layer 202 deposited on a deposited layer 201. The deposited layer 201 is a layer formed first, and is a layer formed on an arrangement surface 61 included in the table 60. The deposited layer 202 is a layer formed second, and is a layer formed on the deposited layer 201. The deposited layer 203 is a layer formed third, and is a layer formed on the deposited layer 202. In each layer, the fabrication material is discharged in an order corresponding to at least one of the discharge material and the region.

The position control unit 14 controls the head moving mechanism 51A, the head moving mechanism 51B, and the table moving mechanism 52 to change the relative position between the discharge head 40 and the table 60. For example, the position control unit 14 controls the head moving mechanism 51A to move the discharge head 40 in the X-axis direction with respect to the table 60. Furthermore, the position control unit 14 controls the head moving mechanism 51B to move the discharge head 40 in the Z-axis direction with respect to the table 60. The position control unit 14 also controls the table moving mechanism 52 to move the table 60 in the Y-axis direction with respect to the discharge head 40.

Specifically, for example, when fabricating the deposited layer 201 that is the lowermost layer, the control unit 10 causes the position control unit 14 included in the control unit 10 to control the head moving mechanism 51B to adjust the height of the discharge head 40 to a height suitable for fabricating the deposited layer 201. Here, when the control unit 10 executes vector control, the position control unit 14 controls the head moving mechanism 51A and the table moving mechanism 52 according to the vector data to move the discharge head 40 in the XY plane orthogonal to the Z-axis. On the other hand, the discharge control unit 13 included in the control unit 10 controls the discharge head 40 according to the vector data to discharge the fabrication material from the discharge head 40.

Furthermore, when the control unit 10 executes the raster control, the position control unit 14 controls the head moving mechanism 51A to move the discharge head 40 little by little along the X-axis direction which is the main scanning direction. On the other hand, the discharge control unit 13 controls the discharge head 40 according to the raster data to discharge the fabrication material from the discharge head 40. When the scanning for one line is completed, the position control unit 14 controls the table moving mechanism 52 to move the table 60 to a position corresponding to the next line along the Y-axis direction which is the sub scanning direction. Similarly for the next line, the position control unit 14 moves the discharge head 40 little by little along the main scanning direction, and the discharge control unit 13 discharges the fabrication material from the discharge head 40 according to the raster data.

Hereinafter, the control unit 10 repeats the above-described processes until the discharge head 40 reaches the position corresponding to the final line and the deposited layer 201 is completed. When the control unit 10 fabricates the deposited layer 202, which is the second layer from the bottom, the position control unit 14 controls the head moving mechanism 51B to adjust the height of the discharge head 40 to a height suitable for fabricating the deposited layer 202. Similarly to the case of fabricating the deposited layer 201, the control unit 10 repeats the above-described processes to fabricate the deposited layer 202. The control unit 10 repeats the process of fabricating one layer until fabrication of the uppermost layer is completed.

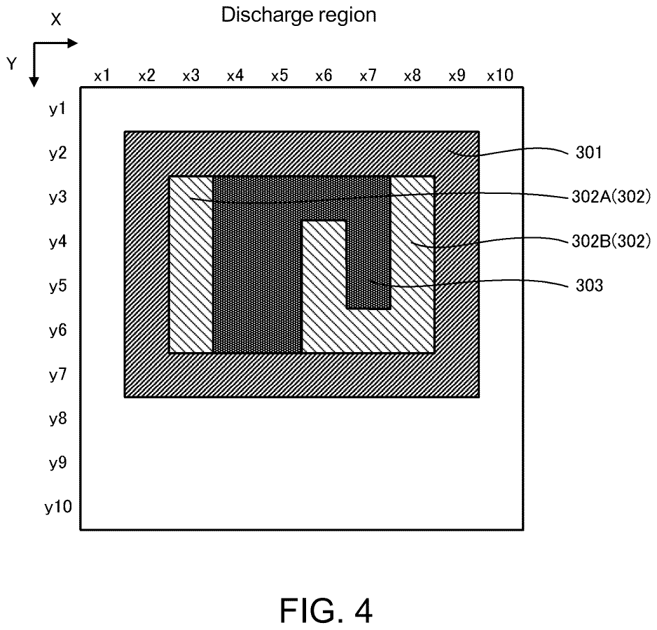

Next, a method of fabricating each layer by the control unit 10 will be described in detail with reference to FIGS. 4, 5, 6, and 7. In the present embodiment, the control unit 10 discharges a soybean paste having a high viscosity to a region corresponding to the outer edge of an artificial meat 200, and then discharges the soybean paste and an oil/fat paste having a low viscosity to a region corresponding to the inner side of the artificial meat 200 to fabricate one layer. Hereinafter, description will be specifically made below.

First, in the present embodiment, the food item fabrication system 100 includes a plurality of discharge heads 40 including a discharge head 40A that discharges a soybean paste and a discharge head 40B that discharges an oil/fat paste. The viscosity of the soybean paste is higher than the viscosity of the oil/fat paste. The soybean paste is an example of a first fabrication material. The oil/fat paste is an example of a second fabrication material. The discharge head 40A is an example of a first discharge head. The discharge head 40B is an example of a second discharge head.

Here, the data generation unit 11 generates slice data including vector data for the soybean paste, raster data for the oil/fat paste, and raster data for the soybean paste. The vector data for the soybean paste is an example of the first vector data. The raster data for the oil/fat paste is an example of the first raster data. The raster data for the soybean paste is an example of the second raster data.

The discharge control unit 13 controls the discharge of the soybean paste by the discharge head 40A based on the vector data for the soybean paste. The discharge control unit 13 controls the discharge of the oil/fat paste by the discharge head 40B based on raster data for the oil/fat paste. The discharge control unit 13 controls the discharge of the soybean paste by the discharge head 40A based on the raster data for the soybean paste.

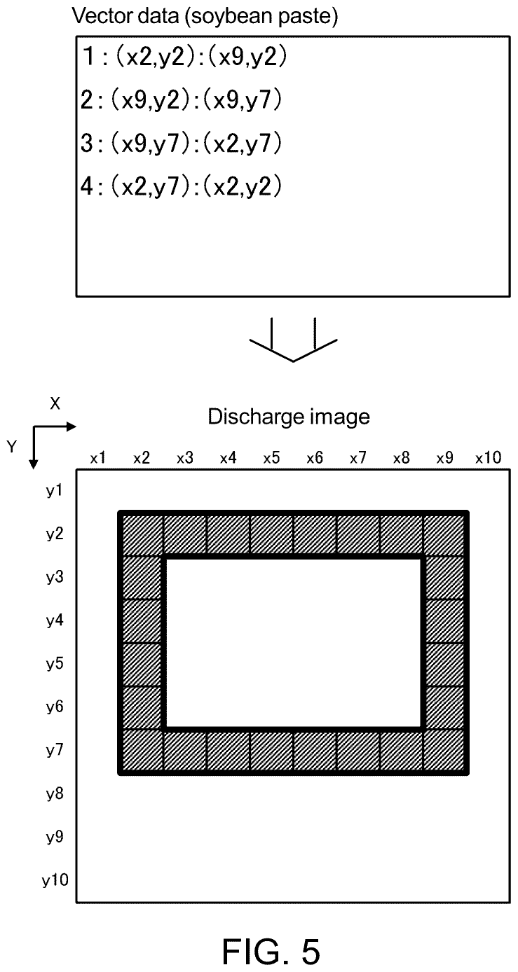

Specifically, first, the discharge control unit 13 controls the discharge head 40A to discharge the soybean paste to a first region, which is a region corresponding to the outer edge of the artificial meat 200, based on the vector data for the soybean paste. In FIG. 4, the region 301 is an example of the first region. FIG. 5 illustrates an image in which the soybean paste is discharged to the first region based on the vector data for the soybean paste.

The vector data is, for example, data indicating a region where the fabrication material is to be discharged by a route through which the discharge head 40 should pass at the time of discharging the fabrication material. The vector data of FIG. 5 indicates that the first region is a route connecting four straight lines. The discharge head 40 discharges the soybean paste while moving along this route. That is, FIG. 5 illustrates that the soybean paste should be discharged on a line connecting the coordinates (x2, y2) and the coordinates (x9, y2), a line connecting the coordinates (x9, y2) and the coordinates (x9, y7), a line connecting the coordinates (x9, y7) and the coordinates (x2, y7), and a line connecting the coordinates (x2, y7) and the coordinates (x2, y2).

Note that the vector data illustrated in FIG. 5 is vector data for one layer. In the present embodiment, an example in which the line indicating the route is a straight line connecting two points will be described, but the line indicating the route may be a curve connecting two points. Furthermore, in the present embodiment, for the sake of easy understanding, a region for one layer is indicated by a region of 10×10=100 specified by 10 coordinates in the X-axis and 10coordinates in the Y-axis.

The discharge control unit 13 controls the discharge head 40A to discharge the soybean paste to the first region based on the vector data for the soybean paste, and then controls the discharge head 40 to discharge the fabrication material to the second region and the third region. Specifically, the discharge control unit 13 executes a process of controlling the discharge head 40B to discharge the oil/fat paste to the second region after the discharge control to the first region. Furthermore, the discharge control unit 13 executes a process of controlling the discharge head 40A to discharge the soybean paste to the third region after the discharge control to the first region.

The second region is a region surrounded by the first region. In FIG. 4, a region 302A and a region 302B are examples of the second region. Note that the region 302A and the region 302B are collectively referred to as a region 302 as appropriate. The third region is a region surrounded by the first region and is a region different from the second region. In FIG. 4, the region 303 is an example of the third region. Note that the order of executing the discharge control for the second region and the discharge control for the third region can be appropriately adjusted. In the present embodiment, the discharge control for the third region is executed after the discharge control for the first region, and thereafter, the discharge control for the second region is executed.

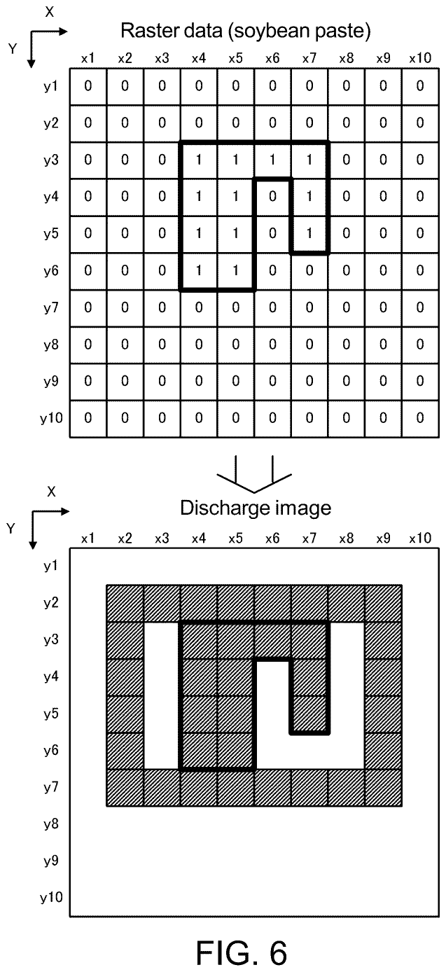

FIG. 6 illustrates an image in which the soybean paste is discharged to the third region based on the raster data for the soybean paste. The raster data for the soybean paste is, for example, data indicating a region where the soybean paste is to be discharged by coordinates. FIG. 6 illustrates an example in which the raster data for the soybean paste indicates a coordinate where the soybean paste is to be discharged as 1 and indicates a coordinate where the soybean paste is not to be discharged as 0. The raster data illustrated in FIG. 6 is raster data for one layer.

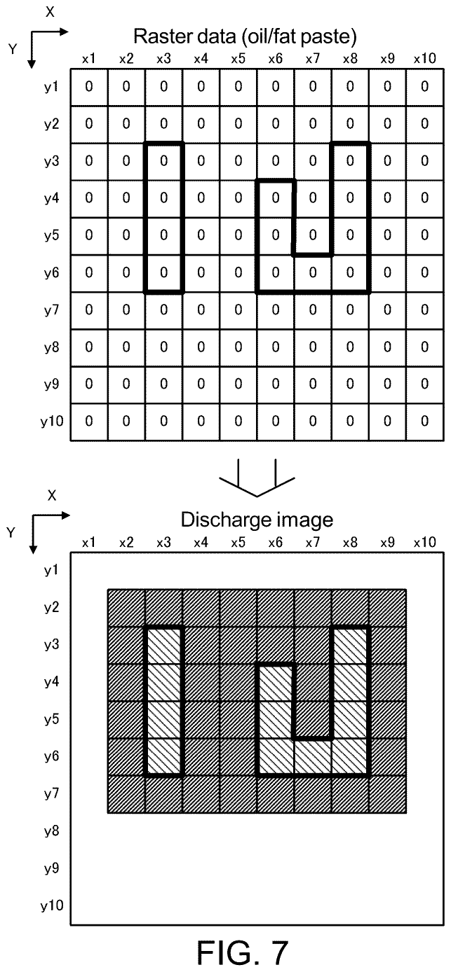

FIG. 7 illustrates an image in which the oil/fat paste is discharged to the second region based on raster data for the oil/fat paste. The raster data for the oil/fat paste is, for example, data indicating a region where the oil/fat paste is to be discharged by coordinates. FIG. 7 illustrates an example in which the raster data for the oil/fat paste indicates a coordinate where the oil/fat paste is to be discharged as 1 and indicates a coordinate where the oil/fat paste is not to be discharged as 0. The raster data illustrated in FIG. 7 is raster data for one layer.

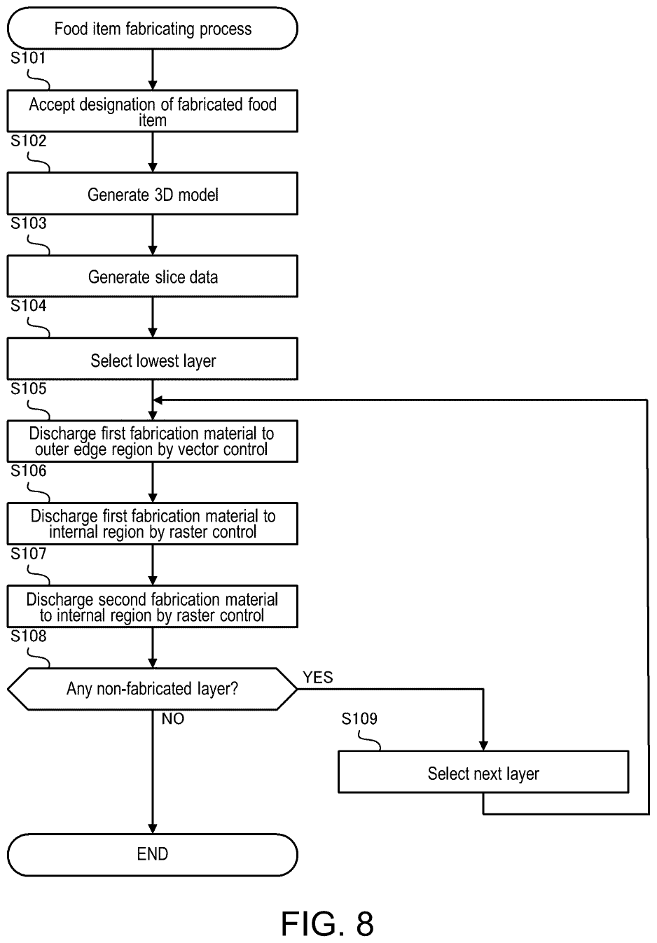

Next, a food item fabricating process executed by the food item fabrication system 100 will be described with reference to a flowchart illustrated in FIG. 8. Note that the food item fabricating process is executed, for example, in response to accepting an operation instructing to start the food item fabricating process from the user after the material tank is filled with the fabrication material by the user.

First, the control unit 10 included in the food item fabrication system 100 accepts designation of a fabricated food item (step S101). For example, the control unit 10 displays a screen for accepting the selection of the type of the fabricated food item on the display unit 22. Then, the control unit 10 specifies the type of the fabricated food item designated by the user based on the operation accepted by the operation acceptance unit 23 from the user. In the present embodiment, the fabricated food item is the artificial meat 200.

Upon completion of the process in step S101, the control unit 10 generates a 3D model (step S102). For example, the control unit 10 generates a 3D model of a fabricated food item of a type designated by the user based on the fabricated object information stored in the storage unit 21. The fabricated object information is, for example, information indicating the shape of the fabricated food item, the size of the fabricated food item, the type of the fabrication material constituting each portion of the fabricated food item, and the like for each type of fabricated food item.

Upon completion of the process in step S102, the control unit 10 generates slice data (step S103). For example, the control unit 10 divides the generated 3D model into planes extending in the horizontal direction, and generates slice data for generating each layer constituting the fabricated food item. The slice data is data indicating a discharge region of each fabrication material for each layer, and includes vector data and raster data.

Upon completion of the process in step S103, the control unit 10 selects the lowermost layer (step S104). That is, the control unit 10 adjusts the position of the discharge head 40 in the Z-axis direction so that the deposited layer 201 which is the lowermost layer can be generated.

Upon completion of the process inf step S104, the control unit 10 discharges the first fabrication material to the outer edge region by vector control (step S105). For example, the control unit 10 controls the position and discharge of the discharge head 40A based on the vector data for the soybean paste, and discharges the soybean paste to the region 301 corresponding to the outer edge region of the artificial meat 200.

Upon completion of the process in step S105, the control unit 10 discharges the first fabrication material to the inner region by raster control (step S106). For example, the control unit 10 controls the position and discharge of the discharge head 40A based on the raster data for the soybean paste, and discharges the soybean paste to the region 303 corresponding to the inner region of the artificial meat 200.

Upon completion of the process in step S106, the control unit 10 discharges the second fabrication material to the inner region by raster control (step S107). For example, the control unit 10 controls the position and discharge of the discharge head 40B based on the raster data for the oil/fat paste, and discharges the oil/fat paste to the region 302 corresponding to the inner region of the artificial meat 200.

Upon completion of the process in step S107, the control unit 10 determines whether or not there is a non-fabricated layer (step S108). That is, the control unit 10 determines whether or not the layer being selected, that is, the layer fabricated immediately before is the uppermost layer of the fabricated food item.

When determining that there is a non-fabricated layer (step S108: YES), the control unit 10 selects the next layer (step S109). That is, the control unit 10 raises the position of the discharge head 40 in the Z-axis direction by one layer so that a layer one layer above the layer fabricated immediately before can be generated. Upon completion of the process in step S109, the control unit 10 returns the process to step S105. When determining that there is no non-fabricated layer (step S108: NO), the control unit 10 finishes the food item fabricating process.

In the present embodiment, the discharge head 40 intermittently discharges the fabrication material having fluidity at the time of discharge. Therefore, according to the present embodiment, a fabricated food item can be accurately fabricated. Furthermore, in the present embodiment, the discharge of each of the plurality of fabrication materials by the plurality of discharge heads 40 is controlled based on the corresponding raster data or vector data. Therefore, according to the present embodiment, a fabricated food item can be accurately fabricated by a plurality of fabrication materials.

In addition, in the present embodiment, the discharge of the fabrication material is controlled based on the vector data and the raster data. Therefore, according to the present embodiment, a fabricated food item can be accurately and quickly fabricated. In particular, in the present embodiment, the first fabrication material is discharged to the first region corresponding to the outer edge of the fabricated food item based on the vector data, and the second fabrication material is discharged to the second region surrounded by the first region based on the raster data. Therefore, according to the present embodiment, the outer edge portion of the fabricated food item can be quickly fabricated, and the inner portion of the fabricated food item can be accurately fabricated.

Furthermore, in the present embodiment, the second fabrication material having a low viscosity is discharged to the second region after the first fabrication material having a high viscosity is discharged to the first region. Therefore, according to the present embodiment, deformation after discharge of the second fabrication material having a low viscosity is suppressed by the first fabrication material having a high viscosity, and the fabricated food item can be accurately fabricated.

In addition, in the present embodiment, a process of discharging the first fabrication material to the first region based on the first vector data and then discharging the second fabrication material to the second region based on the first raster data, and a process of discharging the first fabrication material to the third region surrounded by the first region based on the second raster data are executed. Therefore, according to the present embodiment, the outer edge portion of the fabricated food item can be quickly fabricated, and the inner portion of the fabricated food item can be accurately fabricated using a plurality of fabrication materials.

Furthermore, in the present embodiment, the discharge of each of the plurality of fabrication materials by the plurality of discharge heads 40 is controlled based on the corresponding raster data. Therefore, according to the present embodiment, the fabricated food item can be accurately fabricated by using a plurality of fabrication materials. Furthermore, in the present embodiment, the plurality of discharge heads 40 are arranged side by side in the main scanning direction. Therefore, according to the present embodiment, the plurality of fabrication materials can be efficiently discharged based on the raster data.

Although the embodiments have been described above, modifications and applications according to various forms are possible. Which part of the configuration, function, and operation described in the above embodiment to adopt is arbitrary. In addition to the above-described configuration, function, and operation, further configuration, function, and operation may be adopted. The configuration, function, and operation described in the above-described embodiment can be freely combined.

### Modified Example

In the embodiment, an example of fabricating a fabricated food item using two types of fabrication materials has been described. The fabricated food item may be fabricated using one type of fabrication material, or the fabricated food item may be fabricated using three or more types of fabrication materials. For example, it is suitable to fabricate a fabricated food item having a desired taste or texture using a large number of fabrication materials having different tastes or textures when the fabricated food item is completed.

Furthermore, the same type of fabrication material having different viscosities may be used. For example, a soybean paste having a high viscosity, a soybean paste having a low viscosity, and an oil/fat paste having a low viscosity may be used. In this case, for example, a soybean paste having a high viscosity may be discharged to the outer edge portion using vector data, and then a soybean paste having a low viscosity and an oil/fat paste having a low viscosity may be discharged to the inner portion using raster data.

In the embodiment, an example has been described in which vector data and raster data are generated for the soybean paste, and raster data is generated for the oil/fat paste. The data generated for each fabrication material can be appropriately adjusted. That is, at least one of vector data and raster data may be generated for one fabrication material. For example, only the vector data may be generated for the soybean paste, or only the raster data may be generated for the soybean paste. Furthermore, only the vector data may be generated for the oil/fat paste, or the vector data and the raster data may be generated for the oil/fat paste.

In the embodiment, the example in which the outer edge portion is fabricated with the fabrication material having high viscosity has been described. The outer edge portion may be fabricated with a fabrication material having a low viscosity. In order to make the fabricated food item less likely to lose shape, it is suitable to fabricate the first portion with a fabrication material having a high viscosity and then fabricate the second portion surrounded by the first portion with a fabrication material having a low viscosity.

In the embodiment, an example has been described in which the discharge of the soybean paste using the second raster data is executed, and then the discharge of the oil/fat paste using the first raster data is executed. The discharge of the soybean paste using the second raster data may be executed after the discharge of the oil/fat paste using the first raster data is executed. Alternatively, the discharge of the soybean paste using the second raster data and the discharge of the oil/fat paste using the first raster data may be executed simultaneously.

In the embodiment, an example in which the fabrication material is rapidly naturally dried has been described. When the fabrication material is not rapidly naturally dried, for example, a heater may be provided under the table to promote drying of the discharged fabrication material by heating of the heater. Furthermore, in a case where the fabrication material is quickly fixed by laser irradiation, the discharged fabrication material may be irradiated with laser. Furthermore, in a case where the fabrication material is quickly fixed by mixing with various liquid materials, the liquid material may be mixed with the discharged fabrication material.

Furthermore, in the embodiment, the example has been described in which the moving mechanism 50 includes the head moving mechanism 51A configured to move the discharge head 40 in the X-axis direction, the table moving mechanism 52 configured to move the table 60 in the Y-axis direction, and the head moving mechanism 51B configured to move the discharge head 40 in the Z-axis direction. The moving mechanism 50 may be any mechanism that changes the relative positional relationship between the discharge head 40 and the table 60. That is, the moving mechanism 50 may include a mechanism configured to move at least one of the discharge head 40 and the table 60 in the X-axis direction, a mechanism configured to move at least one of the discharge head 40 and the table 60 in the Y-axis direction, and a mechanism configured to move at least one of the discharge head 40 and the table 60 in the Z-axis direction.

In the embodiment, an example has been described in which a lean portion formed of a soybean paste and a fat portion formed of an oil/fat paste are roughly divided. For example, when fabricating the artificial meat 200 imitating marbled meat, a lean portion formed of a soybean paste and a fat portion formed of an oil/fat paste may be made intricate. Note that when the viscosity of the soybean paste is higher than the viscosity of the oil/fat paste, the soybean paste is suitably discharged before the oil/fat paste in order to suppress loss of shape.

In the embodiment, the example has been described in which the formation of the outer edge portion and the formation of the inner portion are repeated for each layer constituting the fabricated food item. The formation of the outer edge portion and the formation of the inner portion may be repeated for each of the plurality of layers. For example, a process of forming the outer peripheral portion for the two layers with a soybean paste using vector data and a process of forming the inner portion for the two layers with a soybean paste and an oil/fat paste using raster data may be repeated. Specifically, for example, a process of forming the outer peripheral portion of the first layer with a soybean paste, forming the outer peripheral portion of the second layer with a soybean paste, forming the inner portion of the first layer with a soybean paste and an oil/fat paste, and forming the inner portion of the second layer with a soybean paste and an oil/fat paste may be repeated until all the layers are formed.

In the embodiment, in the control unit 10, the CPU functions as each unit illustrated in FIG. 1 by executing a program stored in the ROM or the storage unit 21. However, in the present disclosure, the control unit 10 may be dedicated hardware. The dedicated hardware is, for example, a single circuit, a composite circuit, a programmed processor, an application specific integrated circuit (ASIC), a field-programmable gate array (FPGA), or a combination thereof. In a case where the control unit 10 is dedicated hardware, the functions of the respective units may be realized by individual hardware, or the functions of the respective units may be collectively realized by a single hardware. In addition, some of the functions of the respective units may be implemented by dedicated hardware, and other functions may be implemented by software or firmware. As described above, the control unit 10 can implement each of the above-described functions by hardware, software, firmware, or a combination thereof.

When an operation program that defines the operation of the food item fabrication system 100 according to the present disclosure is applied to a computer such as an existing personal computer or an information terminal device, the computer can be caused to function as the food item fabrication system 100 according to the present disclosure. Furthermore, a distribution method of such a program is arbitrary, and for example, the program may be stored and distributed in a computer-readable recording medium such as a compact disk ROM (CD-ROM), a digital versatile disk (DVD), a magneto optical disk (MO), or a memory card, or may be distributed via a communication network such as the Internet.

The present disclosure enables various embodiments and modified examples without deviating from the broad spirit and scope of the present disclosure. In addition, the above-described embodiments are for describing the present disclosure, and do not limit the scope of the present disclosure. That is, the scope of the present disclosure is indicated by the claims rather than by the embodiments. Various modifications made within the scope of the claims and within the scope of the meaning of the equivalent disclosure are deemed to be within the scope of the present disclosure.

### REFERENCE SIGNS LIST

10 Control unit
11 Data generation unit
12 Viscosity control unit
13 Discharge control unit
14 Position control unit
21 Storage unit
22 Display unit
23 Operation acceptance unit
24 Communication unit
30 Viscosity adjustment mechanism
40, 40A, 40B Discharge head
41 Particle
41A Soybean particle
41B Oil/fat particle
42, 42A, 42B Deposit
50 Moving mechanism
51, 51A, 51B Head moving mechanism
52 Table moving mechanism
60 Table
61 Arrangement surface
100 Food item fabrication system
200 Artificial meat
201, 202, 203 Deposited layer
301, 302, 302A, 302B, 303 Region

1. A food item fabrication system for fabricating a fabricated food item by layering a fabrication material, the food item fabrication system comprising:
a discharge head, configured to intermittently discharge the fabrication material for fabricating the fabricated food item, the fabrication material having a fluidity at a time of discharge;
a data generation unit, configured to generate a slice data for fabricating the fabricated food item; and
a discharge control unit, configured to control a discharge of the fabrication material by the discharge head based on the slice data generated by the data generation unit.

2. The food item fabrication system as set forth in claim 1, further comprising:
a plurality of discharge heads that discharge a plurality of fabrication materials, respectively;
wherein
the data generation unit is configured to generate the slice data including at least one of a data which has a raster data and a vector data for each of the plurality of fabrication materials, and
the discharge control unit is configured to control the discharge of each of the plurality of fabrication materials by the plurality of discharge heads based on the corresponding at least one of the data.

3. The food item fabrication system as set forth in claim 2, wherein
the plurality of discharge heads include:
a first discharge head, configured to discharge a first fabrication material; and
a second discharge head, configured to discharge a second fabrication material,
wherein the data generation unit is configured to generate the slice data including a first vector data that is a vector data for the first fabrication material and a first raster data that is a raster data for the second fabrication material, and
the discharge control unit is configured to:
control a discharge of the first fabrication material by the first discharge head based on the first vector data, and
control a discharge of the second fabrication material by the second discharge head based on the first raster data.

4. The food item fabrication system as set forth in claim 3, wherein
the discharge control unit is configured to:
control the first discharge head to discharge the first fabrication material to a first region that is a region corresponding to an outer edge of the fabricated food item based on the first vector data; and
control the second discharge head to discharge the second fabrication material to a second region that is a region surrounded by the first region based on the first raster data.

5. The food item fabrication system as set forth in claim 4, wherein
a viscosity of the first fabrication material is higher than a viscosity of the second fabrication material, and
the discharge control unit is configured to:
control the first discharge head to discharge the first fabrication material to the first region based on the first vector data; and
then control the second discharge head to discharge the second fabrication material to the second region based on the first raster data.

6. The food item fabrication system as set forth in claim 5, wherein
the data generation unit is configured to generate the slice data including the first vector data, the first raster data, and a second raster data that is a raster data for the first fabrication material, and
the discharge control unit is configured to:
execute a process of controlling the first discharge head to discharge the first fabrication material to the first region based on the first vector data;
then control the second discharge head to discharge the second fabrication material to the second region based on the first raster data; and
execute a process of controlling the first discharge head to discharge the first fabrication material to a third region that is a region surrounded by the first region and different from the second region based on the second raster data.

7. The food item fabrication system as set forth in claim 2, wherein
the plurality of discharge heads include:
a first discharge head, configured to discharge a first fabrication material having a first viscosity; and
a second discharge head, configured to discharge a second fabrication material having a second viscosity lower than the first viscosity,
wherein the discharge control unit is configured to:
control the first discharge head to discharge the first fabrication material; and
then control the second discharge head to discharge the second fabrication material.

8. The food item fabrication system as set forth in claim 2, wherein
the data generation unit is configured to generate the slice data including a raster data for each of the plurality of fabrication materials, and
the discharge control unit is configured to control a discharge of each of the plurality of fabrication materials by the plurality of discharge heads based on the corresponding raster data.

9. The food item fabrication system as set forth in claim 8, wherein
the plurality of discharge heads is arranged side by side in a main scanning direction.

10. A method for fabricating a food item for fabricating a fabricated food item by layering a fabrication material, the method comprising:
intermittently discharging the fabrication material for fabricating the fabricated food item, the fabrication material having a fluidity at a time of discharge;
generating a slice data for fabricating the fabricated food item; and
controlling a discharge of the fabrication material based on the slice data.
